(19) United States
(12) Patent Application Publication
(10) Pub. No.: US 2014/0261223 A1
(43) Pub. Date: Sep. 18, 2014

(54) Pet Scratcher

(71) Applicant: Bradley Grant Gee, Miami, FL (US)

(72) Inventor: Bradley Grant Gee, Miami, FL (US)

(21) Appl. No.: 14/170,958

(22) Filed: Feb. 3, 2014

Related U.S. Application Data
(60) Provisional application No. 61/779,759, filed on Mar. 13, 2013.

(51) Int. Cl. A01K 13/00

(52) U.S. Cl. CPC A01K 13/004
USPC 119/621

(57) ABSTRACT

This invention is designed primarily for domesticated pets, like dogs and cats to scratch themselves on without the help of their owners. Pets can scratch their backs, faces or backsides. There is no need for permanent mounting. The invention can be placed on the floor, wall, picked up and moved, turned over for a different scratching experience, washed, rolled up and put away. This removes the need to deface home furniture or interior walls with screws, glues or other fasteners. Pets are also kept safe.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention is in the technical field of animal scratcher. Dogs and cats enjoy scratching themselves but are limited in option. They typically use household furniture and walls wearing them down and making them dirty. Also, use of household objects presents a possibility of injury. Presently available products focus on and are designed primarily for outdoor livestock such as horses, donkeys, cows, and goats and must be fastened by screw to a fixed object, such as a wall, fence, door or tree. (See patents US D584,863 S and US2011/0217508A) Existing products were not primarily designed for domestic pets like dogs and cats. Additionally, existing products are not appropriate for in home use as they must be attached by screw or other fasteners. Home furniture, walls and doors are not the best place to screw things into. Past patents for in home use are not flexible and could be harmful to pet's eyes, ears, face or other body parts. They cannot be easily washed or stored and don't have alternate scratching surfaces for different pets sizes and preferences. (See Patent # des 387,512)

### BRIEF SUMMARY OF THE INVENTION

This invention is designed primarily for domesticated pets, like dogs and cats to scratch themselves on without the help of their owners. Pets can scratch their backs, faces or backsides. There is no need for screws or permanent mounting. The invention can be placed on the floor, placed against a wall, picked up and moved, turned over for a different scratching experience, washed, rolled up and put away. This removes the need to deface home furniture or interior walls with screws, glues or other fasteners. As the invention is contemplated in flexible rubber silicon, pets are secure from injuring themselves. Household furniture and walls are preserved as pets choose the present invention.

### BRIEF DESCRIPTION OF THE SEVERAL VIEWS OF THE DRAWINGS

FIG. 1 is a top view of one side of the present invention;

FIG. 2 is a section view of a portion of the present invention;

FIG. 2A is a perspective view of a portion of the present invention;

FIG. 3 is a top view of the alternate side of the present invention;

FIG. 4 is a section view of a portion of the alternate side of the present invention;

FIG. 4A is a perspective view of a portion of the alternate side of the present invention;

FIG. 5 is a perspective view of the present invention;

FIG. 6 is a perspective view of the present invention;

FIG. 7 is a perspective view of the present invention.

FIG. 8 is a perspective view of the present invention.

### DETAILED DESCRIPTION OF THE INVENTION

The invention is contemplated as a single and continuous piece made of several components. The invention can be made by injection mold silicon rubber. Several color choices and combinations of colors are contemplated for both the substrate and raised features. Other plastics, rubbers, materials and techniques are also contemplated. The raised features will likely be fabricated of the same material of the substrate, but may differ in both material and color. Different patterns and arrangements of the raised features are contemplated. Raised features could be arranged into an image, such as a dog or cat. Additionally, images and or text on the substrate and raised features are contemplated. Upon pressure the silicon rubber or material of choice is to be flexible, yet durable.

FIG. 1 provides a top view of one side of device 100. Device 100 is referred to as a pet scratcher. Device 100 is a planar substrate, generally rectangular in shape and has a first surface and second surface on each side. Distributed about the side of the first surface is a plurality of raised features. In the FIG. 1, each raised feature 200 is conical, nub, finger or pyramid in shape. Other raised feature shapes are contemplated. In FIG. 1, the raised features are arranged in a periodic pattern. In FIG. 1 the raised features 200 are to be in a uniform pattern of staggered rows. Other patterns are contemplated. The raised features 200 are substantially normal to the substrate surface of device 100. Raised features not substantially normal to the substrate surface are contemplated.

In one example, device 100 has an overall dimension of approximately 42 inches by 30 inches and the substrate of device 100 has a thickness of 0.33 inches. Other substrate thicknesses are contemplated. As illustrated, each raised feature is configured as a cone with a height of 0.75 inches and base diameter of 0.5 inches. Other cone dimensions are contemplated. In one example, the overall length of a cone is 1.08 inches relative to the substrate and the substrate thickness is 0.33 inches. Other dimensions are also contemplated.

In FIG. 1 device 100 has a handle 400 on either side, as illustrated. Handle shapes other than illustrated are also considered. These two handles give the pet owner the option of assisting their pet by rubbing the device 100 over the pets back in a similar fashion to drying ones back after a shower. The handles 400 may also be used to hang the device 100 from when stored. The perimeter of device 100 is to have a border 300 of 0.5 inches. Other border widths are contemplated. The border may have company contact information and product name.

FIG. 2 and FIG. 2A are a section and perspective view of a portion of device 100 respectively. The figures illustrate a general arrangement of raised features 200. Both figures show the thickness 600 of device 100 substrate of 0.33 inches.

FIG. 3 provides a top view of the alternate side of device 100. Device 100 is referred to as a pet scratcher. Device 100 is a planar substrate, generally rectangular in shape and has a first surface and second surface on each side. Distributed about the side of the alternate surface is a plurality of raised features. In the FIG. 3, each raised feature 700 is conical, nub, finger or pyramid in shape. Other raised feature shapes are contemplated. In FIG. 3, the raised features are arranged in a periodic pattern. In FIG. 3 the raised features 700 are to be in a uniform pattern of staggered rows. Other patterns are contemplated. The raised features 700 are substantially normal to the surface of device 100. Raised features not substantially normal to the substrate surface are contemplated.

In one example, device 100 has an overall dimension of approximately 42 inches by 30 inches and the substrate of device 100 has a thickness 600 of 0.33 inches. Other substrate thicknesses are contemplated. As illustrated, each raised feature is configured as a cone with a height of 0.5 inches and base diameter of 0.25 inches. Other cone dimensions are contemplated. In one example, the overall length of a cone is 0.83 inches relative to the substrate and the substrate thickness is 0.33 inches. Other dimensions and are also contemplated.

In FIG. 3 device 100 has a handle 400 on either side, as illustrated. Handle shapes and design other than illustrated are also contemplated. These two handles give the pet owner the option of assisting their pet by rubbing the device 100 over the pets back in manner similar to drying ones back after a shower. The handles 400 may also be used to hang the device 100 from when stored. The perimeter of device 100 is to have a border 300 of 0.5 inches, other border widths are contemplated. The border may have company contact information and product name.

FIG. 4 and FIG. 4A are a section and perspective view of a portion of device 100 respectively. The figures illustrate a general arrangement of raised features 200. Both figures show the thickness 600 of device 100 substrate of 0.33 inches.

FIG. 5 shows a perspective view of device 100 as placed on the floor.

FIG. 6, FIG. 7 & FIG. 8 Show perspective views of device 100 and the flexibility and functionality of the production materials contemplated. That is, its ability to be rolled, twisted and placed against a wall to accommodate a pet and easily stored and washed and used by owner to assist the pet.

The advantages of the present invention include, without limitation, portability—the ability to move it from one place to another, availability—can be used by pets of different stature as it is placed on the floor or leant against a wall, flexibility—both the substrate and cones will be flexible under pressure to make sure the pet does no harm to themselves, convenient—no screws, glues or fasteners are needed and can be easily washed, rolled and stored, optionality—the owner can chose to assist by use of the handles, choice—different size cones on either side and therefore texture to allow for a softer or harder scratching surface.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. I claim the ornamental design shown and described.
